(19) United States
(12) Patent Application Publication
(10) Pub. No.: US 2021/0329907 A1
(43) Pub. Date: Oct. 28, 2021

(54) Conical Anti-Vermin Shield for Wildlife Feeder

(71) Applicant: Ronald J. Juenemann, Phillipsburg, KS (US)

(72) Inventor: Ronald J. Juenemann, Phillipsburg, KS (US)

(21) Appl. No.: 17/236,141

(22) Filed: Apr. 21, 2021

Related U.S. Application Data
(60) Provisional application No. 63/015,518, filed on Apr. 25, 2020.

(51) Int. Cl. A01M 29/30; A01K 5/01

(52) U.S. Cl. CPC A01M 29/30; A01K 5/0107

(57) ABSTRACT

An anti-vermin shield for a wildlife feeder includes a body member formed in a pyramidal configuration that is removably coupled to a leg of a wildlife feeder. The anti-vermin shield slides over each leg of the wildlife feeder and is secured with a ring clamp. The side sections and base member of the anti-vermin shield prevents varmints such as raccoons and squirrels from climbing up the leg of the wildlife feeder. Specifically, the larger end of the body member is directed downwardly prevent a varmint from entering or going around the shield.

### REFERENCE TO RELATED APPLICATIONS

This application claims the benefit of Provisional patent application U.S. 63/015,518 filed Apr. 25, 2020 titled Conical Anti-Vermin Shield for Wildlife Feeder, which is incorporated herein in its entirety.

### BACKGROUND OF THE INVENTION

This invention relates generally to wildlife feeder shields and, more particularly, to an anti-vermin shield that is removably coupled to a leg of a wildlife feeder and that includes a pyramidal shape that prevents vermin from climbing up the leg.

Hunting is one of the most popular pastimes for many people. The Outdoor Industry Association's Outdoor Recreation Economy Report states that approximately 23 billion was spent on hunting and roughly 33 billion was spent on wildlife viewing. Topline Report estimates more than 27 million Americans went hunting in 2016. Further, many retailers sell wild game feeders, including Cabela's, Bass Pro Shop, Sportsman's Guide, Dick's Sporting Goods and many others. These feeders supply corn, milo, beans and other foods and minerals to wildlife such as deer, turkeys, and pigs for both hunting and wildlife viewing.

Unfortunately, however, squirrels and raccoons crawl up the legs of the feeder and eat and drop food on the ground which is costly. An even more expensive problem is that many feeders have spinners and timers. These varmints chew through wires, hang on spinner devices, and ruin them. Even worse, most feeders are made of plastic and they can be totally ruined by the wildlife. Feeders can be ruined because these animals will chew through the plastic and create holes in the feeder. Rain, snow, and all kinds of weather get into the feeder and spoil the food supply.

Therefore, it would be desirable to have an anti-vermin shield having a generally pyramidal shape for attachment to a leg of a wildlife feeder that prevents unwanted wildlife from climbing up the leg and damaging the feeder or accessing grain therein. Further, it would be desirable to have an anti-vermin shield that attaches quickly and easily to virtually any wildlife feeder so as to be retrofit to existing feeders already in operation. In addition, it would be desirable to have an anti-vermin shield having a larger lower opening and then narrowing to an apex so as to slowly deter and cause a curious animal to reverse course.

### SUMMARY OF THE INVENTION

An anti-vermin shield for a wildlife feeder according to the present invention includes a body member formed in a 4-sided pyramidal configuration that is removably coupled to a leg of a wildlife feeder. The anti-vermin shield slides over each leg of the wildlife feeder and is secured with a ring clamp. The increasingly narrowing shape of the anti-vermin shield prevents varmints such as raccoons and squirrels from climbing up the leg of the wildlife feeder. Specifically, the larger profile of the shield and closed bottom wall are positioned downwardly such that a varmint is stopped by the decreasing diameter thereof. The specific geometry of the recited invention is critical to the structure and function of this invention.

Therefore, a general object of this invention is to provide an anti-vermin shield that prevents nuisance wildlife, such as raccoons and squirrels, from climbing up a leg of a wildlife feeder.

Another object of this invention is to provide an anti-vermin shield, as aforesaid, having a pyramidal configuration that defines an increasingly smaller interior area so as to discourage and stop an animal from advancing.

Still another object of this invention is to provide an anti-vermin shield, as aforesaid, that is removably coupled to a leg of a wildlife feeder, such as with a ring clamp.

Yet another object of this invention is to provide an anti-vermin shield, as aforesaid, that is economical to produce and to purchase.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an anti-vermin shield according to a preferred embodiment of the present, illustrated attached to the legs of a wildlife feeding apparatus;

FIG. 2a is a perspective view of the anti-vermin shield as in FIG. 1, illustrated removed from the wildlife feeding apparatus;

FIG. 2b is an isolated view on an enlarged scale taken from FIG. 2a;

FIG. 2c is a fragmentary view of the anti-vermin shield as in FIG. 2a, illustrated with some panels removed for clarity; and

FIG. 3 is an exploded view of the anti-vermin shield as in FIG. 2a.

### DESCRIPTION OF THE PREFERRED EMBODIMENT

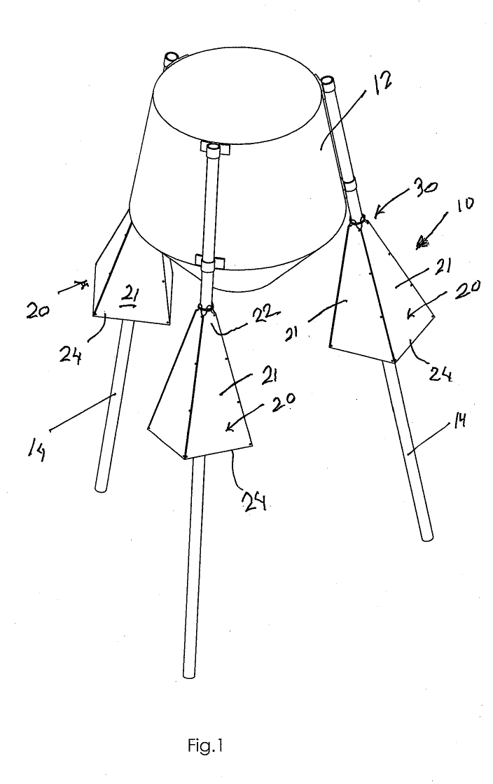

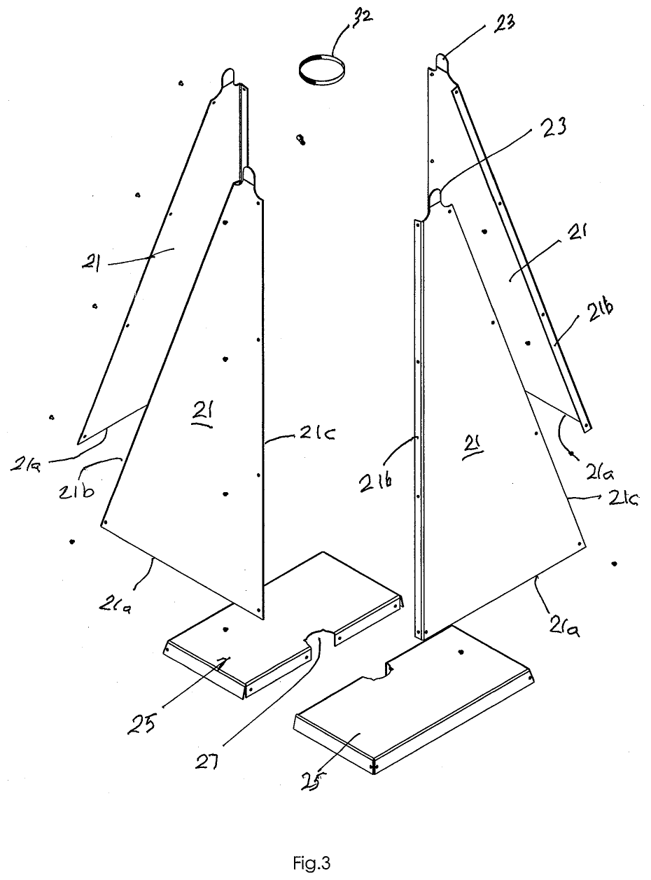

An anti-vermin shield for a wildlife feeder according to a preferred embodiment of the present invention will now be described with reference to FIGS. 1 to 3 of the accompanying drawings. The anti-vermin shield 10 includes a body member 20 that may be shaped into a generally pyramidal configuration and secured to a leg 14 of a wildlife feeder 12 with a ring clamp 32.

The anti-vermin shield 10 may include a body member 20 constructed of a thin and lightweight metal, such as 29-gauge tin or the like. Specifically, 29-gauge metal is the thinnest metal ever recommended for roofing as it may not hold up as well to high wind or severe weather conditions as the thicker 24-gauge metal. Specifically, the body member 20 may include four side sections 21 each having a generally triangular shape configuration that, when coupled together, form a pyramidal structure defining a small interior area at a top end 22 and a large interior area at a bottom end 24. The body member 20 may have a plurality of side sections 21 each having a triangular configuration that may be coupled together with fasteners, such as bolts. The side sections 21 extend upwardly from a base member 25. In an embodiment, the base member 25 may be closed or have a solid construction that defines an aperture 27 dimensioned for receiving a respective leg 14 of a feeder 12 but otherwise preventing a varmint from entering the interior area of the shield 10. In other words, the base member 25 has a geometric area large enough that the side sections 21 rising therefrom are extended outwardly from the leg 14 of the feeder sufficiently to prevent a varmint from traveling along the leg 14 beyond the bottom end 24 of the feeder 12.

With further reference to the construction and geometrical configuration of the side sections 21, each side section 21 has a lower edge 21a coupled to a peripheral edge of the base member 25 and has a pair of opposed side edges 21a, 21b extending away from opposed ends of the base member 25 in a converging manner. In other words, each side section 21 has a wider configuration adjacent its respective bottom end 24 and a converged or smaller width adjacent its top end 22. Correspondingly, the interior area defined by the side sections 21 is larger adjacent the bottom end 24 than the interior area defined by the side sections 21 adjacent the top end 22. As described above, a closed bottom end 24 and relatively wide at the bottom end 24 prevents a varmint from crawling up a leg 14 of the feeder 12.

Alternatively, an embodiment the body member may have a unitary or integrated construction and a conical shape configuration, such as could be formed through an extrusion process. In an embodiment, it is possible for the bottom end 24 to be open or removed from the design, in which case varmints may enter the interior space defined by the side sections but will still be prevented from progressing along the leg 14 by the convergence of the side sections.

Even more particularly, a preferred embodiment of the anti-vermin shield 10 may include a height of about 16 inches. The bottom end 24 may define a geometric area of about 16 inches and the top end 22 may have a geometric area of about 2.0 inches. The larger bottom end 24 is directed downwardly on a wildlife feeder leg 14 so that a varmint is stopped both by the closed base member 25 positioned adjacent the bottom end 24 and by the outwardly extended side sections 21.by a decreasing geometric area toward the top end 22 and have no other choice but to back out of the anti-vermin shield 10 altogether. To be clear, the bottom end 24 and top end 22 are open.

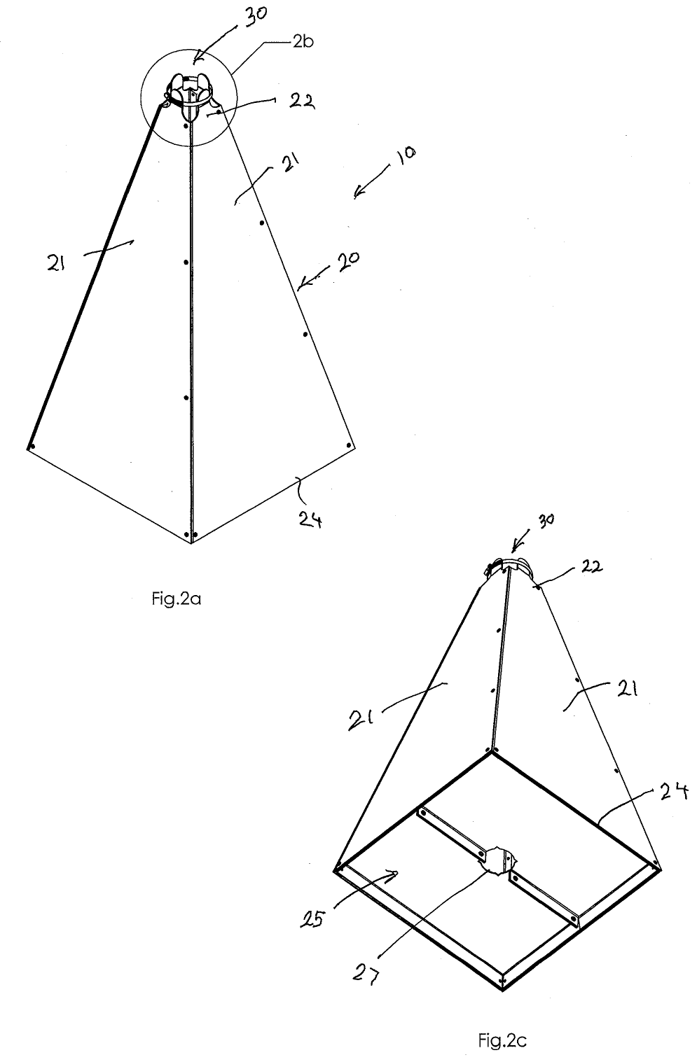

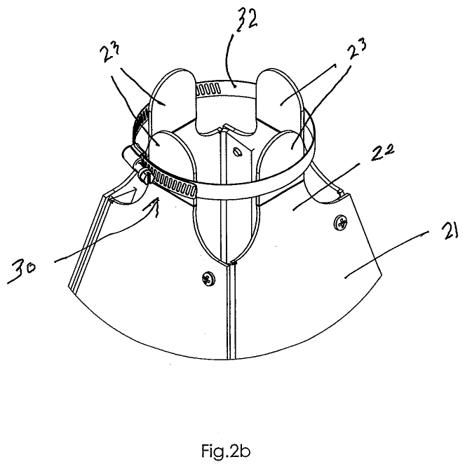

Each anti-vermin shield 10 may include a leg clamping assembly 30. In an embodiment, the top end 22 of each side section 21 includes an attachment tab 23. Each attachment tab 23 has a unitary construction with the respective side section 21 from which it extends. Further, each attachment tab 23 has a planar configuration and is co-planar with the flat configuration of the respective side section 21. Then, to couple the body member 20 a respective leg 14 of the wildlife feeder 12, the leg clamping assembly 30 may include a ring clamp 32 cinched tightly about respective attachment tabs 23 (so as to sandwich the attachment tabs 23 to the leg 14) (FIG. 2a and 2b). It is understood that the ring clamp 32 may be a hose clamp.

In another embodiment (shown in the related provisional application), the leg clamping assembly 30 may include a plurality of clamping straps coupled to the body member 20 adjacent to and extending upwardly from the top end 22. Then, to couple the body member 20 a respective leg 14 of the wildlife feeder 12, the ring clamp 32 is cinched tightly about upper ends of the plurality of clamping straps (so as to sandwich said straps to the leg 14).

In use, an anti-vermin shield 10 is removably coupled to each leg 14 of a wildlife feeder 12. Attachment may occur in several ways. Specifically, a leg 14 may be lifted up (such as by rocking an empty feeder to its side) and then inserting the anti-vermin shield 10 top end 22 first onto the exposed feet of respective legs 14. Or, the body member 20 may, at first be open or even flat and then be closed (and side sections 21 secured together as described above) shaped at a desired location about a respective leg 14 and then fastened closed. Then, an anti-vermin shield 10 is coupled to the leg 14 with a ring clamp 32 as described above.

It is understood that while certain forms of this invention have been illustrated and described, it is not limited thereto except insofar as such limitations are included in the following claims and allowable functional equivalents thereof.

1. An anti-vermin shield for preventing varmints from climbing up a leg of a feeder, said anti-vermin shield comprising:
a body member that includes a plurality of side sections each having a lower edge and a pair of spaced apart side edges extending away from opposed ends of said lower edge in a converging manner that, together, form a triangular configuration in a singular plane;
wherein each side section includes a tab positioned at an upper end proximate said convergence of said side edges, respectively, said tab being in said singular plane;
wherein a respective tab of a respective side section is coupled to an adjacent tab of an adjacent side section so that, together said plurality of side sections are coupled together via said adjacent tabs and said coupled side sections, that, together, define an interior space and an open bottom.

2. The anti-vermin shield as in claim 1, further comprising a base member having a plurality of peripheral edges along which each lower edge of said plurality of side sections corresponds and from which said plurality of side sections extend upwardly.

3. The anti-vermin shield as in claim 2, wherein said base member is positioned so as to connect respective lower edges and closing said open bottom.

4. The anti-vermin shield as in claim 3, wherein said base member has a planar configuration.

5. The anti-vermin shield as in claim 2, wherein said plurality of side sections extend upwardly and inwardly at an acute angle relative to said base member so that a geometric area of said interior area becomes smaller approaching said upper end.

6. The anti-vermin shield as in claim 1, wherein said base member defines an aperture for receiving the leg of the feeder.

7. The anti-vermin shield as in claim 1, further comprising a clamping assembly coupling respective tabs of said plurality of side sections, respectively, together about the leg of the feeder.

8. The anti-vermin shield as in claim 7, wherein said clamping assembly includes a ring clamp having an elongate configuration that cinches said respective tabs together with a selectable tightness.

9. The anti-vermin shield as in claim 8, wherein said ring clamp is a hose clamp.

10. The anti-vermin shield as in claim 1, wherein said body member has an open top having a diameter that is complementary to selectively receive the leg of the feeder.

11. An anti-vermin shield for preventing varmints from climbing up a leg of a feeder, said anti-vermin shield comprising:
a body member that includes a plurality of side sections each having a lower edge and a pair of spaced apart side edges extending away from opposed ends of said lower edge in a converging manner that, together, form a triangular configuration in a singular plane;
wherein each side section includes a tab positioned at an upper end proximate said convergence of said side edges, respectively, said tab being in said singular plane;
wherein a respective tab of a respective side section is coupled to an adjacent tab of an adjacent side section so that, together said plurality of side sections are coupled together via said adjacent tabs and said coupled side sections, that, together, define an interior space and an open bottom;
a base member having a plurality of peripheral edges coupled to respective lower edge of said plurality of side sections, respectively, such that said plurality of side sections extend upwardly said plurality of side sections.

12. The anti-vermin shield as in claim 11, wherein said body member is a metal sheet constructed of thin and lightweight tin material.

13. The anti-vermin shield as in claim 12, wherein said body member is constructed of 29-gauge metal.

14. The anti-vermin shield as in claim 11, wherein said plurality of side sections, together, form a four-sided pyramidal configuration.

15. The anti-vermin shield as in claim 11, wherein said base member has a planar configuration.

16. The anti-vermin shield as in claim 11, wherein said plurality of side sections extend upwardly and inwardly at an acute angle relative to said base member so that a geometric area of said interior area becomes smaller approaching said upper end.

17. The anti-vermin shield as in claim 11, wherein said base member defines an aperture for receiving the leg of the feeder.

18. The anti-vermin shield as in claim 11, further comprising a clamping assembly for coupling respective tabs of said plurality of side sections, respectively, together about the leg of the feeder.

19. The anti-vermin shield as in claim 18, wherein said clamping assembly includes a ring clamp having an elongate configuration that cinches said respective tabs together with a selectable tightness.

20. The anti-vermin shield as in claim 11, wherein said tab has a rounded configuration intermediate a pair of shoulder sections for enhancing a grip of the clamping assembly.
